(19) United States
(12) Patent Application Publication
(10) Pub. No.: US 2022/0134843 A1
(43) Pub. Date: May 5, 2022

(54) CAB HEATING SYSTEM FOR AN ELECTRIC WORK VEHICLE

(71) Applicant: CNH Industrial America LLC, New Holland, PA (US)

(72) Inventors: Christopher Alan Andreuccetti, Burlington, IA (US); Justin Mehmert, Fort Madison, IA (US); Joseph E. Borg, Burlington, IA (US); Richard Niespodzany, Mediapolis, IA (US); Douglas K. Braswell, Dubuque, IA (US)

(21) Appl. No.: 17/512,275

(22) Filed: Oct. 27, 2021

Related U.S. Application Data
(60) Provisional application No. 63/107,846, filed on Oct. 30, 2020.

(51) Int. Cl. B60H 1/22; B60H 1/00

(52) U.S. Cl. CPC B60H 1/2206; B60H 1/00342; B60H 1/00392; B60H 2001/00307; B60H 1/00885; B60H 1/00271; B60H 1/00378

(57) ABSTRACT

In one aspect, a cab heating system for an electric work vehicle includes a hydraulic circuit forming a hydraulic flow loop through which a hydraulic fluid is directed for supply to a hydraulic component of the electric work vehicle. The system also includes a coolant circuit forming a coolant flow loop through which a coolant fluid is circulated, with the coolant circuit comprising a coolant heat exchanger. Additionally, the system includes a circuit heat exchanger thermally coupling the hydraulic circuit to the coolant circuit to allow heat to be transferred between the hydraulic fluid and the coolant fluid, and a fan configured to direct an airflow across the coolant heat exchanger such that heat is transferred from the coolant fluid to the airflow prior to delivery of the airflow into an interior of a cab of the electric work vehicle.

### FIELD OF THE INVENTION

The present disclosure generally relates to electric work vehicles and, more particularly, to a cab heating system for an electric work vehicle, such as an electric backhoe loader or any other electric construction vehicle.

### BACKGROUND OF THE INVENTION

Traditional engine-driven work vehicles, such as conventional construction vehicles, typically provide in-cab heating using the engine as the primary heat source. However, for electric work vehicles, cab heating systems must rely other heat sources. For instance, cab heating systems for current electric work vehicles within the market often utilize a cab-based electrical resistance heater in combination with a fan to generate a heated airflow for heating the interior of the operator's cab. Still other cab heating systems rely upon an electric heater as the sole source for heating a refrigerant being cycled through a corresponding refrigeration circuit or rely upon a complex heat pump system. Unfortunately, such systems typically require a significant amount of energy and, thus, reduce the operational range of the vehicle given the significant amount of power being drawn from the battery.

Accordingly, a need exists for an improved cab heating system that addresses one or more of the deficiencies of the prior art systems, such as a new system that allows for an operator's cab of an electric work vehicle to be heated in a more efficient manner.

### SUMMARY OF THE INVENTION

Aspects and advantages of the technology will be set forth in part in the following description, or may be obvious from the description, or may be learned through practice of the technology.

In one aspect, the present subject matter is directed to a cab heating system for an electric work vehicle. The system includes a hydraulic circuit forming a hydraulic flow loop through which a hydraulic fluid is directed for supply to a hydraulic component of the electric work vehicle. The system also includes a coolant circuit forming a coolant flow loop through which a coolant fluid is circulated, with the coolant circuit comprising a coolant heat exchanger. Additionally, the system includes a circuit heat exchanger thermally coupling the hydraulic circuit to the coolant circuit to allow heat to be transferred between the hydraulic fluid and the coolant fluid, and a fan configured to direct an airflow across the coolant heat exchanger such that heat is transferred from the coolant fluid to the airflow prior to delivery of the airflow into an interior of a cab of the electric work vehicle.

In another aspect, the present subject matter is directed to an electric work vehicle. The vehicle includes a chassis extending in a longitudinal direction between a first end of the chassis and an opposed second end of the chassis, a cab supported between the first and second ends of the chassis, a work implement assembly positioned at one of the first end or the second end of the chassis, and a hydraulic component provided in operative association with the work implement assembly. The vehicle also includes a cab heating system. The system includes a hydraulic circuit forming a hydraulic flow loop through which a hydraulic fluid is directed for supply to the hydraulic component and a coolant circuit forming a coolant flow loop through which a coolant fluid is circulated, with the coolant circuit comprising a coolant heat exchanger. In addition, the system includes a circuit heat exchanger thermally coupling the hydraulic circuit to the coolant circuit to allow heat to be transferred between the hydraulic fluid and the coolant fluid, and a fan configured to direct an airflow across the coolant heat exchanger such that heat is transferred from the coolant fluid to the airflow, with the heated airflow being directed into the cab to provide heating within the interior thereof.

In a further aspect, the present subject matter is directed to a method for heating an operator's cab of an electric work vehicle. The method includes circulating a hydraulic fluid through a hydraulic circuit of the electric work vehicle, and circulating a coolant fluid through a coolant circuit of the electric work vehicle, with the coolant circuit being thermally coupled to the hydraulic circuit via a circuit heat exchanger. The method also includes transferring heat from the hydraulic fluid to the coolant fluid as the hydraulic and coolant fluids are directed through the circuit-to-circuit heat exchanger, and supplying the heated coolant fluid through a coolant heat exchanger of the coolant circuit. In addition, the method includes directing an airflow across the coolant heat exchanger such that heat is transferred from the coolant fluid to the airflow prior to delivery of the airflow into an interior of the operator's cab of the electric work vehicle.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of an electric work vehicle in accordance with aspects of the present subject matter;

FIG. 2 illustrates a schematic view of one embodiment of a cab heating system for an electric work vehicle in accordance with aspects of the present subject matter; and

FIG. 3 illustrates a schematic view of another embodiment of a cab heating system for an electric work vehicle in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a cab heating system for an electric work vehicle. In several embodiments, the cab heating system includes a coolant circuit that is thermally coupled to a corresponding hydraulic circuit of the electric work vehicle. For instance, as will be described below, a circuit heat exchanger (e.g., a fluid-to-fluid heat exchanger) may be used to thermally couple the coolant circuit to the hydraulic circuit, thereby allowing waste heat contained within the hydraulic fluid being circulated through the hydraulic circuit to be transferred to the coolant fluid being circulated through the coolant circuit. The heated coolant fluid may then be directed through a coolant/cab heat exchanger to allow heat to be transferred from coolant fluid to an airflow being directed across the heat exchanger. The heated airflow may then be directed though suitable ducting into the interior of the operator's cab for providing heating therein. In this regard, by using the waste heat generated by the vehicle's hydraulic system as the primary heat source, the coolant fluid may be passively heated without requiring any power usage, thereby providing increased operational life for the electric work vehicle.

Additionally, in several embodiments, the cab heating system may also incorporate an additional heat source(s) beyond the heat generated by the hydraulic system. Such additional heat source(s) may be advantageously used, for example, in association with cold start-ups of the electric work vehicle. For instance, in one embodiment, an electric tank heater may be provided in association with the hydraulic tank to allow the hydraulic fluid to be heated (e.g., to a temperature at or above a threshold temperature). The electric tank heater may, for example, be used to pre-heat the hydraulic fluid while the vehicle is in a non-operational state, in which case the power source for the tank heater need not necessarily correspond to the vehicle's on-board battery. Specifically, in one embodiment, the electric tank heater may be operated during charging of the vehicle's battery such that the external power source used for battery charging may also serve as the power source for the tank heater. Moreover, in addition to the tank heater (or as an alternative thereto), an electric coolant heater may be provided in operative association with the coolant circuit. In such an embodiment, the coolant heater may be configured, for example, to be activated or turned on for a short period of time (e.g., at initial start-up) to provide supplemental heating for the coolant fluid while the hydraulic fluid within the hydraulic circuit is being heated (e.g., via operation of the vehicle's hydraulic system). Once the hydraulic fluid has been sufficiently heated to a temperature at which the hydraulic fluid may, itself, provide sufficient heating to the coolant fluid (e.g., via the heat transfer provided by the circuit heat exchanger), the coolant heater may be deactivated or turned off to conserve power.

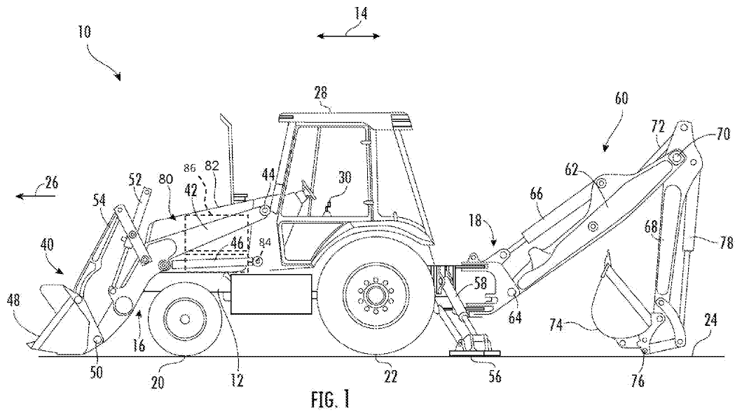

Referring now to the drawings, FIG. 1 illustrates a side view of one embodiment of an electric work vehicle in accordance with aspects of the present subject matter. As shown, the electric work vehicle is configured as an electric backhoe loader 10 (also often referred to as a “tractor-loader-backhoe” (TLB) or a “loader backhoe). However, in other embodiments, aspects of the present subject matter may also be utilized within other electric work vehicles, such as various other construction vehicles. For instance, in one embodiment, aspects of the present subject matter may be advantageously utilized with other electric construction vehicles including at least one hydraulically driven component or work implement assembly, such as a wheel loader, a skid-steer loader, and/or a bulldozer.

As shown in FIG. 1, the backhoe loader 10 includes a frame or chassis 12 extending in a longitudinal direction (indicated by arrow 14 in FIG. 1) of the vehicle between a forward end 16 of the chassis 12 and an aft end 18 of the chassis 12. In general, the chassis 12 may be configured to support or couple to a plurality of components. For example, a pair of steerable front traction devices (e.g., front wheels 20 (one of which is shown)) and a pair of driven rear traction devices (e.g., rear wheels 22 (one of which is shown)) may be coupled to the chassis 12. The wheels 20, 22 may be configured to support the backhoe loader 10 relative to a ground surface 24 and move the loader 10 along the ground surface 24 in a direction of travel, such as a forward direction of travel (e.g., as indicated by arrow 26 in FIG. 1). However, in alternative embodiments, the front wheels 20 may be driven in addition to or in lieu of the rear wheels 22. Additionally, an operator's cab 28 may be supported by a portion of the chassis 12 positioned between the forward and aft ends 16, 18 of the chassis 12, and may house one or more operator control devices 30 (e.g., a joystick(s), a lever(s), and/or the like) for permitting an operator to control the operation of the backhoe loader 10.

The backhoe loader 10 also includes a pair of hydraulically driven work implement assemblies positioned at the opposed ends 16, 18 of the chassis 12. Specifically, in the illustrated embodiment, the backhoe loader 10 includes a loader assembly 40 supported by or relative the chassis 12 at or adjacent to its forward end 16. As shown in FIG. 1, the loader assembly 40 includes a loader arm 42 pivotably coupled or supported relative to the chassis 12 at a loader arm pivot point 44, and a loader lift cylinder 46 secured between the loader arm 42 and the chassis 12. In such an embodiment, extension/retraction of the loader lift cylinder 46 may result in the loader arm 42 pivoting upwards/downwards about its respective pivot point 44, thereby allowing the positioning of the loader arm 42 relative to both the chassis 12 and the ground surface 24 to be adjusted, as desired. Moreover, as shown in FIG. 1, the loader assembly 40 further includes a first work implement 48, such as a loader bucket, coupled to the loader arm 42 at an implement pivot point 50, and a first implement tilt cylinder 52 secured between the work implement 48 (e.g., via a linkage(s) 54) and a portion of the loader arm 44. As such, extension/retraction of the first implement tilt cylinder 52 may result in the first work implement 48 pivoting upwards/downwards relative to the loader arm 42 about its respective pivot point 50, thereby permitting the tilt angle or orientation of the implement 48 to be adjusted, as desired. Thus, by controlling the operation of the lift and tilt cylinders 46, 52 of the loader assembly 40, the vertical positioning and orientation of the first work implement 48 may be adjusted to allow for the execution of one or more operations, such as one or more material-moving operations.

Additionally, the backhoe loader 10 includes a backhoe assembly 60 supported by or relative the chassis 12 at or adjacent to its aft end 18. As shown in FIG. 1, the backhoe assembly 60 includes a boom 62 pivotably coupled or supported relative to the chassis 12 at a boom pivot point 64, and a boom lift cylinder 66 secured between the boom 62 and the chassis 12. In such an embodiment, extension/retraction of the boom cylinder 66 may result in the boom 62 pivoting upwards/downwards about its respective pivot point 64, thereby allowing the positioning of the boom 62 relative to both the chassis 12 and the ground surface 24 to be adjusted, as desired. The backhoe assembly 60 also includes a dipper arm 68 coupled to the boom 62 at a dipper pivot point 70, and a dipper cylinder 72 secured between the dipper arm 68 and the boom 62. In such an embodiment, extension/retraction of the dipper cylinder 72 may result in the dipper arm 68 pivoting upwards/downwards about its respective pivot point 70 relative to the boom 62. Moreover, as shown in FIG. 1, the backhoe assembly 60 further includes a second work implement 74, such as a dipper bucket, coupled to the dipper arm 68 at an implement pivot point 76, and a second implement tilt cylinder 78 secured between the work implement 74 and a portion of the dipper arm 68. As such, extension/retraction of the second implement tilt cylinder 78 may result in the second work implement 74 pivoting upwards/downwards relative to the dipper arm 68 about its respective pivot point 76, thereby permitting the tilt angle or orientation of the implement 74 to be adjusted, as desired. Thus, by controlling the operation of the various cylinders 66, 72, 78 of the backhoe assembly 60, the vertical positioning and orientation of the second work implement 74 may be adjusted to allow for the execution of one or more operations, such as one or more material excavation operations.

As shown in FIG. 1, the backhoe loader 10 may also include a pair of stabilizer legs 56 (one of which is shown) positioned at or adjacent to the aft end 18 of the chassis 12. The stabilizer legs 56 may be configured to support the weight of the backhoe loader 10 and/or otherwise stabilize the vehicle during the performance of a backhoe-related operation. For instance, the stabilizer legs 56 may be pivotably coupled to the chassis 12 to allow the legs 56 to be moved or pivoted (e.g., via the operation of an associated stabilizer leg cylinder 58) between a lowered position, at which the legs 56 contact the ground surface 24, and a raised position, at which the legs 56 are lifted off the ground surface 24 to allow the backhoe loader 10 to be moved (e.g., in the forward direction of travel 26). It should be appreciated that, in addition to lowering the stabilizer legs 56, the loader assembly 40 may also be lowered during the performance of a backhoe-related operation such that the first work implement 48 contacts the ground, thereby providing a point-of-contact to stabilize the front end 16 of the chassis 12.

Additionally, the backhoe loader 10 may also include a storage compartment 80 (e.g., positioned in front or forward of the operator's cab 26 relative to the forward direction of travel 26). In one embodiment, the storage compartment 80 may be defined by one or more walls of the vehicle's body, such as, for example, a hood 82 configured to extend over and cover the storage compartment 80. In general, a storage volume defined by the storage compartment 80 may be configured to provide or function as storage space for various components of the backhoe loader 10, such as one or more power storage and/or control components, one or more drivetrain components, and/or one or more cooling assembly components. For instance, as shown in FIG. 1, an electric traction motor 84 may be positioned within the storage compartment 80 that is configured to transmit torque through the vehicle's electric drivetrain for rotationally driving the wheels 20, 22. Additionally, one or more other components of the vehicle's electric drivetrain may also be housed or at least partially housed within the forward storage compartment 80, such as a torque converter and a portion of the vehicle's transmission. Moreover, a power storage device, such as a battery module 86, may also be positioned within the storage compartment 80. As is generally understood, the battery module 86 may be configured to store electrical power for use in powering the various power-consuming components of the vehicle 10, such as the electric traction motor 84 and/or the like.

As indicated above, it should be appreciated that, in other embodiments, the present subject matter may be advantageously applied within various other electric work vehicles, such as various other electric construction vehicles. For instance, in addition to a backhoe loader, aspects of the present subject matter may also be applied within electric construction vehicles only including a single work implement assembly positioned at one end of the vehicle's chassis, such as a wheel loader, skid-steer loader, bulldozer, and/or the like.

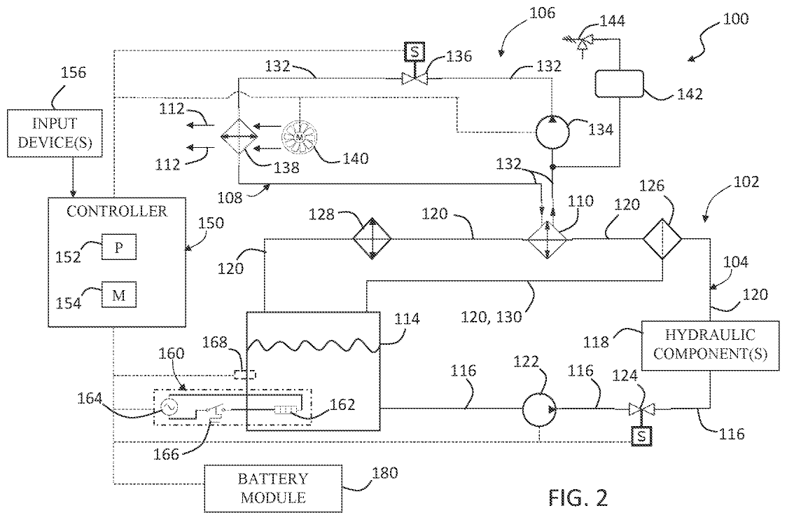

Referring now to FIG. 2, a schematic view of one embodiment of a cab heating system 100 for an electric work vehicle is illustrated in accordance with aspects of the present subject matter. For purposes of description, the system 100 will generally be described with reference to providing heat within the cab 28 of the electric work vehicle 10 shown in FIG. 1. However, in general, it should be appreciated that the disclosed system 100 may be used for heating the operator's cab of any other suitable electric work vehicle having any other suitable vehicle configuration.

In several embodiments, the system 100 includes a hydraulic circuit 102 forming a hydraulic flow loop 104 (e.g., an open loop due to the fluid being returned to and supplied from a tank) for circulating a hydraulic fluid (e.g., oil) and a coolant circuit 106 forming a coolant flow loop 108 (e.g., a closed loop) for circulating a coolant fluid (e.g., a water-glycol mix). In accordance with aspects of the present subject matter, the hydraulic circuit 102 may be configured to be thermally coupled to the coolant circuit 106 to allow heat to be transferred from the hydraulic fluid circulating through the hydraulic flow loop 104 to the coolant fluid circulating trough the coolant flow loop 108. Specifically, as shown in FIG. 2, the system 100 may include a circuit heat exchanger 110 provided in operative association with both the hydraulic circuit 102 and the coolant circuit 106. For instance, the circuit heat exchanger 110 may correspond to a fluid-to-fluid heat exchanger (e.g., a fluid cooler) through which both the hydraulic fluid and the coolant fluid are supplied, thereby allowing heat transfer from the hydraulic fluid to the coolant fluid. As a result, the waste heat generated within the hydraulic circuit 102 may be transferred to the coolant circuit 106 to heat the coolant fluid, thereby allowing the coolant fluid to be used as a heat source for providing a heated airflow (indicated by arrows 112) to the operator's cab 28 (FIG. 1) of the associated electric work vehicle.

As shown in FIG. 2, the hydraulic circuit 102 comprises a hydraulic tank 114, one or more supply lines 116 for supplying hydraulic fluid from the tank 114 to one or more hydraulic components 118 of the electric work vehicle 10, and one or more return lines 120 for returning the hydraulic fluid from the hydraulic component(s) 118 back to the tank 114. As indicated above, the electric work vehicle 10 may include various hydraulic components, such as a loader lift cylinder 46, a first implement tilt cylinder 52, a boom lift cylinder 66, a dipper cylinder 72, a second implement tilt cylinder 78, and a stabilizer leg cylinder 58. In such an embodiment, the supply and return lines 116, 120 may correspond to any suitable number of fluid conduits, tubes, and/or the like for supplying hydraulic fluid from the tank 114 to the various hydraulic components 118 and for returning such hydraulic fluid back to the tank 114.

Additionally, as shown in FIG. 2, the hydraulic circuit 102 also includes various supply-side components, such as a hydraulic circuit pump 122 (e.g., an electric pump) for pumping the hydraulic fluid from the tank 114 through the supply line(s) 116 and one or more hydraulic circuit control valve(s) 124 positioned downstream of the pump 122 for regulating the supply of hydraulic fluid to each hydraulic component(s) 118. In one embodiment, the pump 122 and/or the control valve(s) 124 may be configured as an electronically controlled component(s). For instance, as will be described below, the system 100 may include a controller 150 configured to control the operation of the pump 122 and/or the control valve(s) 124 for controlling the supply of hydraulic fluid to the hydraulic component(s) 118 of the electric work vehicle 10.

Moreover, as shown in FIG. 2, the hydraulic circuit 102 further includes various return-side components, such as a return filter 126 for filtering the hydraulic fluid being returned back to the tank 114 via the return line(s) 120 and a secondary heat exchanger 128 for removing heat from the hydraulic fluid. In one embodiment, the return filter 126 may incorporate a bypass circuit to allow the hydraulic fluid to bypass the downstream heat exchangers 110, 128 in certain instances (e.g., during high pressure conditions). In such an embodiment, as shown in FIG. 2, one of the return line(s) 120 may be correspond to a bypass line 130 fluidly coupled between the return filter 126 and the tank 114 to provide a return flow path for the hydraulic fluid that bypasses the heat exchangers 110, 128. Additionally, as shown in FIG. 2, the secondary heat exchanger 128 (e.g., an oil cooler) may be positioned downstream of the circuit heat exchanger 110 to provide either a primary or auxiliary means for removing heat from the hydraulic fluid, depending on whether coolant fluid is currently being circulated through the coolant circuit 106. For instance, when coolant fluid is not being circulated through the coolant circuit 106, the secondary heat exchanger 128 may function as the primary means for removing heat from the hydraulic fluid.

Referring still to FIG. 2, the coolant circuit 106 generally includes one or more coolant lines 132 (e.g., one or more hoses, conduits, and/or the like) forming the coolant flow loop 108 for circulating the coolant fluid through the various components of the circuit 106. As shown in the illustrated embodiment, the coolant circuit 106 includes a coolant pump 134 (e.g., an electric pump) for pumping the coolant fluid through the coolant line(s) 132 and a coolant control valve 136 positioned downstream of the pump 134 (e.g., relative to the flow direction of the coolant fluid) for regulating the flow of coolant fluid through the circuit 106. In one embodiment, the pump 134 and/or the control valve 146 may be configured as an electronically controlled component(s). For instance, as will be described below, the system controller 150 may be configured to control the operation of the pump 134 and/or the control valve(s) 136 for regulating the flow of coolant fluid circulated through the coolant circuit 106.

Additionally, in several embodiments, the coolant circuit 106 includes a coolant heat exchanger 138 positioned downstream (e.g., relative to the flow direction of the coolant fluid) of the control valve 136. In general, the coolant heat exchanger 138 is provided within the coolant circuit 106 to allow heat to be transferred from the coolant fluid to an airflow 112 bound for delivery to the operator's cab 28 of the electric work vehicle 10. Specifically, as shown in FIG. 2, a fan 140 (e.g., an electric fan) may be positioned relative to the coolant heat exchanger 138 such that the fan 40 is configured to direct an airflow 112 across the coolant heat exchanger 138, thereby allowing for heat transfer from the coolant fluid to the airflow. The heated airflow 112 may then be directed through suitable ducting for delivery into the interior of the operator's cab 38 (e.g., via vents within the cab 38).

As shown in FIG. 2, the coolant heat exchanger 38 is positioned upstream (e.g., relative to the flow direction of the coolant fluid) of the circuit heat exchanger 110. Thus, as the coolant fluid is circulated through the coolant circuit 106, heat is extracted from the coolant fluid via the airflow across the coolant heat exchanger 138. The cooled coolant fluid is then directed through the circuit heat exchanger 110 to re-heat the coolant fluid (i.e., via the heat transferred from the hydraulic fluid). The heated coolant fluid is then cycled back through the coolant flow loop 108 (e.g., through the pump 134 and the control valve 136) to the coolant heat exchanger 138 for again heating the airflow 112 generated by the fan 140. As such, the continuous heat transfer process occurring as the coolant fluid is cycled through the coolant flow loop 108 allows heat to be extracted from the hydraulic fluid at the circuit heat exchanger 110 and transferred to the airflow at the coolant heat exchanger 138 to provide a heated airflow 112 for delivery into the interior of the operator's cab 28.

It should be appreciated that the coolant circuit 106 may also include any other suitable components. For instance, as shown in FIG. 2, the coolant circuit 106 may include an expansion tank 142 and/or an associated tank cap/valve 144. As is generally understood, the expansion tank 142 may be included within the coolant circuit 106 to accommodate thermal expansion of the coolant fluid, while the tank cap/valve 144 may allow air to be purged from the coolant circuit 106.

As indicated above, the system 100 may also include a controller 150 configured to control the operation of one or more other components of the system 100. In general, the controller 150 may correspond to any suitable processor-based device(s), such as a computing device or any combination of computing devices. Thus, in several embodiments, the controller 150 may include one or more processor(s) 152 and associated memory device(s) 154 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 154 of the controller 150 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 154 may generally be configured to store suitable computer-readable instructions that, when implemented by the processor(s) 152, configure the controller 150 to perform various computer-implemented functions, such as the processing and/or control functionality described herein.

It should be appreciated that the controller 150 may be configured to interface with and/or be incorporated into existing hardware and/or software of the electric work vehicle 10. In other words, the controller 150 may be configured as a separate unit forming part of the disclosed system 100 and/or may be integrated with the vehicle 10. For instance, the vehicle 10 may have a dedicated vehicle controller which controls specific vehicle-related functions, and the controller 150 may either be in the form of the dedicated vehicle controller or be incorporated as part of the dedicated vehicle controller.

As indicated above, the controller 150 may be communicatively coupled to one or more of the various system components to allow the controller 150 to electronically control the operation of such component(s). For instance, as shown in FIG. 2, the controller 150 is communicatively coupled to one or more of the components included within or associated with the coolant circuit 106, such as the coolant pump 134, the coolant control valve 136, and the fan 138. Similarly, the controller 150 is also communicatively coupled to one or more of the components included within or associated with the hydraulic circuit 102, such as the hydraulic circuit pump 122 and the hydraulic control valve 124. In general, the controller 150 may be configured to control the operation of any of the system components coupled thereto based on, for example, sensor feedback associated with the operation of the system 100 and/or based on any other suitable inputs (e.g., inputs received from the operator) or using any other suitable control methodology.

As shown in FIG. 2, in one embodiment, the controller 150 may be communicatively coupled to one or more operator-controlled input devices 156 located within the operator's cab 28. As such, the controller 150 may be configured to receive various operator-initiated control commands for controlling the operation of one or more of the system components. For instance, suitable input devices, such as knobs, buttons, and/or the like, may be provided within the operator's cab 28 to allow the operator to adjust one or more settings associated with the cab heating system 100, such as one or more airflow settings (e.g., the temperature of the heated airflow 112 being supplied into the interior of the operator's cab 28 and/or the rate at which the heated airflow is supplied thereto). For instance, based on inputs received from the operator, the controller 150 may be configured to control the operation of the coolant pump 134, the coolant control valve 136, and/or the fan 140 to adjust airflow settings (e.g., temperature and/or flow rate).

Referring still to FIG. 2, in several embodiments, the system 100 may also include a tank heater 160 provided in operative association with the hydraulic tank 114. In general, the tank heater 160 may be configured to heat the hydraulic fluid contained within the tank 114. In one embodiment, the tank heater 160 may correspond to a self-regulated tank heater. For instance, as shown in FIG. 2, the tank heater 160 may include an electric heating element 162 and a power source 164 configured to be electrically coupled to the heating element 162 via a thermal switch 166. In such an embodiment, the thermal switch 166 may be configured to close the circuit between the heating element 162 and the power source 164 when the temperature of the hydraulic fluid within the tank 114 falls below a given threshold temperature (e.g., 100-120 degrees Fahrenheit). As a result, the tank heater 160 may be used to maintain the fluid temperature of the hydraulic fluid at or above the threshold temperature. Alternatively, the tank heater 160 may correspond to an electronically controlled heater. For instance, in one embodiment, the controller 150 may be coupled to both the tank heater 160 and a temperature sensor (indicated by dashed lines 168) configured to monitor the fluid temperature of the hydraulic fluid within the tank 114. In such an embodiment, the controller 150 may be configured to electronically activate/deactivate the tank heater 160 based on the temperature feedback received from the temperature sensor 168. For instance, the controller 150 may be configured to monitor the temperature of the hydraulic fluid and activate the tank heater 160 when the fluid temperature falls below a given threshold temperature.

In several embodiments, the tank heater 160 may be used to pre-heat the hydraulic fluid contained within the tank 114 while the electric work vehicle 10 is in a non-operational state. Specifically, when the vehicle 10 is turned off (e.g., overnight), the tank heater 160 may remain operational to maintain the temperature of the hydraulic fluid at or above a given threshold temperature. Such pre-heating allows the hydraulic fluid to be at the proper temperature for use immediately upon turning on or otherwise starting up the vehicle 10, which can be particularly advantageous for cold start-ups in which the ambient temperature around the vehicle 10 is below a given temperature threshold (e.g., below freezing) Specifically, even in instances of significantly cold ambient temperatures, the pre-heating provided by the tank heater may allow the hydraulic fluid to be maintained at the proper temperature for immediate use within the hydraulic circuit not only for operating the hydraulic components(s), but also for heating the coolant fluid via the circuit heat exchanger. As a result, the pre-heated hydraulic fluid may be immediately available for heating the coolant fluid and, thus, may facilitate providing faster in-cab heating (e.g., despite any cold start-up conditions).

In one embodiment, the pre-heating provided via the tank heater 160 may occur simultaneously with charging of the vehicle's power storage component(s), such as a battery module 180 (e.g., the battery module 86 of vehicle 10). Specifically, in most instances, an electric work vehicle will be charged when the vehicle is in a non-operational state. For instance, it is typical for an electric work vehicle to be plugged into an external power source overnight for charging the battery module 180 while the vehicle is not being operated. In such instance, it may be advantageous to operate the tank heater 160 during such battery charging process, as the external power source can also be used as a power source for the tank heater. As a result, the tank heater may function to heat the hydraulic fluid within the tank without draining the battery. Moreover, since battery charging typically occurs during nighttime hours, the simultaneous pre-heating of the hydraulic fluid allows the fluid to be maintained at the desired temperature despite colder overnight temperatures.

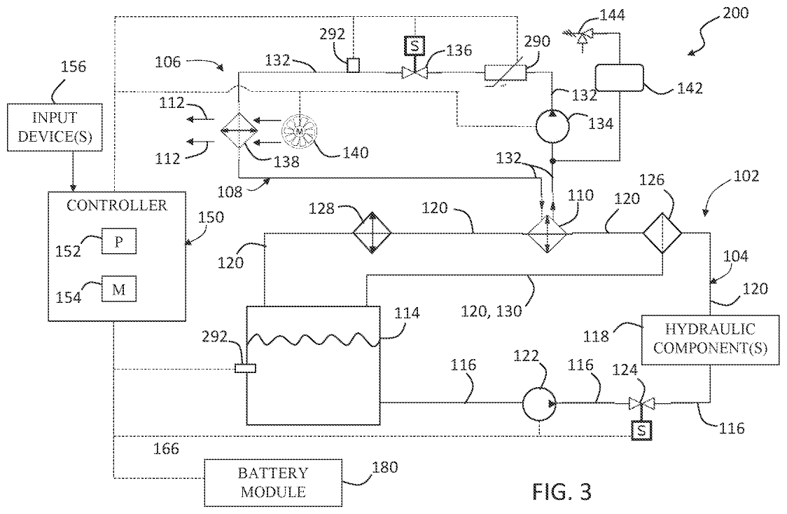

Referring now to FIG. 3, a schematic view of another embodiment of a cab heating system 200 for an electric work vehicle is illustrated in accordance with aspects of the present subject matter. In most aspects, the system 200 of FIG. 3 is generally configured the same as or similar to the system 100 described above with reference to FIG. 2. Thus, the same reference characters are used in FIG. 3 to identify the same or similar components as those described above with reference to FIG. 2. In this regard, such components are generally configured to function as outlined above, and, thus, will not be described again with reference to FIG. 3 to avoid repetition.

As shown in FIG. 3, unlike the embodiment of the system 100 described above, the system 200 incorporates an inline coolant heater 290 (e.g., an electric heater) within the coolant circuit 200. Specifically, as shown in the illustrated embodiment, the coolant heater 290 is positioned downstream of the coolant pump 134 and upstream of the coolant control valve(s) 136. However, in other embodiments, the coolant heater 290 may be disposed at any other suitable position along the coolant flow loop 108 that allows the heater 290 to function as described herein.

In several embodiments, the coolant heater 290 may be configured to function as an additional or supplementary heat source for heating the coolant fluid. For instance, during start-up conditions in which the hydraulic fluid is at lower temperatures, the coolant heater 290 may be activated to provide a supplementary heating source for the coolant fluid until the hydraulic fluid has been sufficiently heated via operation of the hydraulic system. In such embodiments, the controller 150 may, for example, be configured to electronically control the operation of the coolant heater 290 based on the fluid temperature of the coolant fluid within the coolant circuit and/or the hydraulic fluid within the hydraulic circuit. For example, as shown in FIG. 3, a first temperature sensor 292 may be provided in fluid communication with the coolant circuit to sense the temperature of the coolant fluid, while a second temperature sensor 294 may be provided in fluid communication with the hydraulic circuit (e.g., at the tank 114) to sense the temperature of the hydraulic fluid. As such, the controller 150 may be configured to monitor the fluid temperatures based on the feedback provided by the sensors 292, 294 and subsequently control the operation of the coolant heater 290 based on the monitored temperatures.

For instance, in one embodiment, the controller 150 may be configured to monitor the temperature of the coolant fluid relative to a coolant temperature threshold. In such an embodiment, the controller 150 may be configured to activate the coolant heater when the temperature of the coolant fluid is below the coolant temperature threshold and deactivate the coolant heater when the temperature of the coolant fluid is at or above the coolant temperature threshold. As such, during a cold start-up in which the coolant fluid may be substantially below the coolant temperature threshold, the coolant heater may be activated to quickly heat the coolant fluid to the coolant temperature threshold to allow the coolant fluid to serve as a heat source for heating the operator's cab 28 of the electric work vehicle 10. In addition to such coolant fluid temperature monitoring (or as an alternative thereto), the controller 150 may be configured to monitor the temperature of the hydraulic fluid relative to a hydraulic temperature threshold. In such an embodiment, the controller 150 may be configured to activate the coolant heater when the temperature of the hydraulic fluid is below the hydraulic temperature threshold and deactivate the hydraulic heater when the temperature of the hydraulic fluid is at or above the hydraulic temperature threshold. For instance, the hydraulic temperature threshold may be associated with a fluid temperature at which the hydraulic fluid may, itself, provide sufficient heating to the coolant fluid (e.g., via the heat transfer provided by the circuit heat exchanger 110). In such instance, when it is detected that the temperature of the hydraulic fluid has reached the hydraulic temperature threshold, the coolant heater may be deactivated or turned off to conserve energy.

It should be appreciated that, in the illustrated embodiment, the system 200 of FIG. 3 is shown without inclusion of the tank heater 160 described above with reference to FIG. 2. Specifically, in one embodiment, the coolant heater 290 may be provided as an alternative to the tank heater 160. For instance, during cold start-ups, the coolant heater 290 may be used to sufficiently heat the coolant fluid without requiring any pre-heating or supplementary heating of the hydraulic oil. However, in other embodiments, the system 200 may also incorporate the tank heater 160. For example, the combination of both the tank heater 160 and the coolant heater 290 may, in certain instances, allow for quicker response times in providing in-cab heating, particularly during cold start-ups. Specifically, in one embodiment, the tank heater 160 may be used to pre-heat the hydraulic fluid while the vehicle is in a non-operational state (e.g., during offline battery charging) and the coolant heater 290 may be used to provide temporary supplemental heating to the coolant fluid 290 during initial start-up of the electric work vehicle. For instance, at start-up, the pre-heated hydraulic fluid may begin to be circulated through the hydraulic circuit, thereby allowing heat to be transferred to the coolant fluid via the circuit heat exchanger. In such instance, to expedite the heating of the coolant fluid, the coolant heater 290 may be temporarily activated to provide an additional heat source for the coolant fluid (e.g., until the fluid reaches the desired temperature).

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A cab heating system for an electric work vehicle, the system comprising:
a hydraulic circuit forming a hydraulic flow loop through which a hydraulic fluid is directed for supply to a hydraulic component of the electric work vehicle;
a coolant circuit forming a coolant flow loop through which a coolant fluid is circulated, the coolant circuit comprising a coolant heat exchanger;
a circuit heat exchanger thermally coupling the hydraulic circuit to the coolant circuit to allow heat to be transferred between the hydraulic fluid and the coolant fluid; and
a fan configured to direct an airflow across the coolant heat exchanger such that heat is transferred from the coolant fluid to the airflow prior to delivery of the airflow into an interior of a cab of the electric work vehicle.

2. The system of claim 1, wherein the coolant circuit further comprises a control valve configured to regulate the flow of coolant fluid through the coolant flow loop.

3. The system of claim 1, wherein the hydraulic circuit comprises a tank, one or more supply lines through which the hydraulic fluid is suppled from the tank to the hydraulic component, and one or more return lines through which the hydraulic fluid is returned back to the tank; and
further comprising a tank heater provided in operative association with the tank, the tank heater being configured to heat the hydraulic fluid within the tank.

4. The system of claim 3, wherein the circuit heat exchanger is positioned downstream of the hydraulic component such that the hydraulic fluid being returned to the tank via the one or more return lines passes through the circuit heat exchanger.

5. The system of claim 1, wherein the coolant circuit further comprises a coolant heater configured to heat the coolant fluid being circulated through the coolant flow loop.

6. The system of claim 1, further comprising a controller configured to control an operation of one or more components of the system.

7. The system of claim 6, wherein the coolant circuit further comprises a control valve in fluid communication with the coolant fluid loop, the controller being configured to control an operation of the control valve to regulate the flow of coolant fluid to the coolant heat exchanger.

8. The system of claim 7, wherein the controller is communicatively coupled to an input device, the controller being configured to control an operation of at least one of the control valve or the fan based on inputs received from the input device.

9. The system of claim 6, wherein the coolant circuit further comprises a coolant heater configured to heat the coolant fluid being circulated through the coolant flow loop, the controller being configured to control an operation of the coolant heater.

10. The system of claim 9, wherein the controller is configured to control the operation of the coolant heater based at least in part on a fluid temperature of at least one of the coolant fluid or the hydraulic fluid.

11. The system of claim 6, wherein the hydraulic circuit comprises a tank, one or more supply lines through which the hydraulic fluid is suppled from the tank to the hydraulic component, and one or more return lines through which the hydraulic fluid is returned back to the tank; and
further comprising a tank heater provided in operative association with the tank, the tank heater being configured to heat the hydraulic fluid within the tank;
wherein the controller is configured to control an operation of the tank heater.

12. An electric work vehicle, comprising:
a chassis extending in a longitudinal direction between a first end of the chassis and an opposed second end of the chassis;
a cab supported between the first and second ends of the chassis;
a work implement assembly positioned at one of the first end or the second end of the chassis;
a hydraulic component provided in operative association with the work implement assembly; and
a cab heating system comprising:
a hydraulic circuit forming a hydraulic flow loop through which a hydraulic fluid is directed for supply to the hydraulic component;
a coolant circuit forming a coolant flow loop through which a coolant fluid is circulated, the coolant circuit comprising a coolant heat exchanger;
a circuit heat exchanger thermally coupling the hydraulic circuit to the coolant circuit to allow heat to be transferred between the hydraulic fluid and the coolant fluid; and
a fan configured to direct an airflow across the coolant heat exchanger such that heat is transferred from the coolant fluid to the airflow,
wherein the heated airflow is directed into the cab to provide heating within the interior thereof.

13. The electric work vehicle of claim 12, wherein the coolant circuit further comprises a control valve configured to regulate the flow of coolant fluid through the coolant flow loop.

14. The electric work vehicle of claim 12, wherein the hydraulic circuit comprises a tank, one or more supply lines through which the hydraulic fluid is suppled from the tank to the hydraulic component, and one or more return lines through which the hydraulic fluid is returned back to the tank; and
further comprising a tank heater provided in operative association with the tank, the tank heater being configured to heat the hydraulic fluid within the tank.

15. The electric work vehicle of claim 14, wherein the circuit heat exchanger is positioned downstream of the hydraulic component such that the hydraulic fluid being returned to the tank via the one or more return lines passes through the circuit heat exchanger.

16. The electric work vehicle of claim 12, wherein the coolant circuit further comprises a coolant heater configured to heat the coolant fluid being circulated through the coolant flow loop.

17. The electric work vehicle of claim 12, further comprising a controller configured to control an operation of one or more cab heating components of the system.

18. The electric work vehicle of claim 17, wherein the coolant circuit further comprises a control valve provided in fluid communication with the coolant flow loop, the controller being configured to control an operation of the control valve to regulate the flow of coolant fluid supplied to the coolant heat exchanger.

19. The electric work vehicle of claim 18, wherein the controller is communicatively coupled to an input device, the controller being configured to control an operation of at least one of the control valve or the fan based on inputs received from the input device.

20. The electric work vehicle of claim 17, wherein the coolant circuit further comprises a coolant heater configured to heat the coolant fluid being circulated through the coolant flow loop, the controller being configured to control an operation of the coolant heater.

21. The electric work vehicle of claim 20, wherein the controller is configured to control the operation of the coolant heater based at least in part on a fluid temperature of at least one of the coolant fluid or the hydraulic fluid.

22. The electric work vehicle of claim 17, wherein the hydraulic circuit comprises a tank, one or more supply lines through which the hydraulic fluid is suppled from the tank to the hydraulic component, and one or more return lines through which the hydraulic fluid is returned back to the tank; and
further comprising a tank heater provided in operative association with the tank, the tank heater being configured to heat the hydraulic fluid within the tank;
wherein the controller is configured to control an operation of the tank heater.

23. The electric work vehicle of claim 12, wherein the first end of the chassis comprises a forward end of the chassis and the second end of the chassis comprises an aft end of the chassis, the work implement assembly comprising a loader assembly positioned at the forward end of the chassis, the loader assembly including a loader arm supported relative to the chassis and a first work implement pivotably coupled to the loader arm.

24. The electric work vehicle of claim 23, further comprising a backhoe assembly positioned at the aft end of the chassis, the backhoe assembly including at least one arm supported relative to the chassis and a second work implement pivotably coupled to the at least one arm.

25. A method for heating an operator's cab of an electric work vehicle, the method comprising:
circulating a hydraulic fluid through a hydraulic circuit of the electric work vehicle;
circulating a coolant fluid through a coolant circuit of the electric work vehicle, the coolant circuit being thermally coupled to the hydraulic circuit via a circuit heat exchanger;
transferring heat from the hydraulic fluid to the coolant fluid as the hydraulic and coolant fluids are directed through the circuit-to-circuit heat exchanger;
supplying the heated coolant fluid through a coolant heat exchanger of the coolant circuit; and
directing an airflow across the coolant heat exchanger such that heat is transferred from the coolant fluid to the airflow prior to delivery of the airflow into an interior of the operator's cab of the electric work vehicle.

26. The method of claim 25, further comprising pre-heating the hydraulic fluid within a hydraulic tank of the hydraulic circuit prior to directing the hydraulic fluid through the circuit heat exchanger.

27. The method of claim 26, wherein pre-heating the hydraulic fluid within the hydraulic tank comprises pre-heating the hydraulic fluid within the hydraulic tank while the electric work vehicle is in a non-operational state.

28. The method of claim 27, wherein pre-heating the hydraulic fluid within the hydraulic tank comprises pre-heating the hydraulic fluid within the hydraulic tank while the electric work vehicle is in the non-operational state and a power storage device of the electric work vehicle is being charged.

29. The method of claim 26, further comprising supplying additional heat to the coolant fluid via a coolant heat provided in association with the coolant circuit.
